(19) United States
(12) Patent Application Publication
(10) Pub. No.: US 2014/0031068 A1
(43) Pub. Date: Jan. 30, 2014

(54) REGIONAL INFORMATION DISTRIBUTION SERVER, MOBILE TERMINAL, REGIONAL INFORMATION DISTRIBUTION SYSTEM, REGIONAL INFORMATION DISTRIBUTION METHOD, AND REGIONAL INFORMATION DISPLAY METHOD

(71) Applicants: Naoharu Yamada, Chiyoda-ku (JP); Yuuichirou Miyazaki, Chiyoda-ku (JP); Akira Ishii, Chiyoda-ku (JP); Yoshinori Isoda, Chiyoda-ku (JP)

(72) Inventors: Naoharu Yamada, Chiyoda-ku (JP); Yuuichirou Miyazaki, Chiyoda-ku (JP); Akira Ishii, Chiyoda-ku (JP); Yoshinori Isoda, Chiyoda-ku (JP)

(73) Assignee: NTT DOCOMO, INC., Chiyoda-ku, Tokyo (JP)

(21) Appl. No.: 14/110,092

(22) PCT Filed: Apr. 6, 2012
(86) PCT No.: PCT/JP2012/059592

§ 371 Date: Oct. 4, 2013

(30) Foreign Application Priority Data
Apr. 8, 2011 (JP) 2011-086054

(51) Int. Cl. H04W 4/02

(52) U.S. Cl. CPC H04W 4/02
USPC 455/456.3

(57) ABSTRACT

A regional information distribution server for distributing regional information to a mobile terminal includes a posted message obtaining unit configured to obtain posted messages related to a region from a server for storing posted messages; location information receiving unit configured to receive location information of the mobile terminal from the mobile terminal; an associated posted message obtaining unit configured to obtain a posted message associated with the location information of the mobile terminal from the posted messages obtained by the posted message obtaining unit; and an associated posted message distributing unit configured to distribute the posted message obtained by the associated posted message obtaining unit to the mobile terminal.

### TECHNICAL FIELD

The present invention relates to a regional information distribution server, a mobile terminal, a regional information distribution system, a regional information distribution method, and a regional information display method.

### BACKGROUND ART

There are services in which users post messages related to a region on a server and the server distributes the posted messages (for example, see “Jorudan Live!” (Internet, http://www.jorudan.co.jp/unk/live.html), “waze” (Internet, http://world.waze.com), and “Weather News” (Internet, http://weathernews.jp)). In these services, users post messages according to a format defined in each service and the server distributes all the posted messages.

### DISCLOSURE OF INVENTION

### Problem(s) to be Solved by the Invention

However, in these services, the server can only distribute a message posted according to the format defined in each service. In addition, when a user wish to view messages related to an interesting region, the user has to select them by himself, because all the posted messages are distributed.

On the other hand, a service called “Twitter” is provided. Twitter is a service in which users post a message called a “tweet” and each user can view the tweet. In Twitter, posted messages from followed users are displayed in chronological order. However, when a user wishes to view messages related to an interesting region, the user has to select them by himself.

In this manner, while various types of information are posted on the server, it is cumbersome for a user to select messages related to an interesting region from the posted messages. As the amount of information increases, it is more complicated to select messages related to an interesting region.

It is a general object of the present invention for a user to easily select messages related to an interesting region among posted messages.

### Means for Solving the Problem(s)

In one aspect of the present invention, there is provided a regional information distribution server for distributing regional information to a mobile terminal, including:

a posted message obtaining unit configured to obtain posted messages related to a region from a server for storing posted messages;

a location information receiving unit configured to receive location information of the mobile terminal from the mobile terminal;

an associated posted message obtaining unit configured to obtain a posted message associated with the location information of the mobile terminal from the posted messages obtained by the posted message obtaining unit; and

an associated posted message distributing unit configured to distribute the posted message obtained by the associated posted message obtaining unit to the mobile terminal.

In another aspect of the present invention, there is provided a mobile terminal for receiving regional information from a regional information distribution server, including:

a location information obtaining unit configured to obtain location information of the mobile terminal and transmit the location information to the regional information distribution server;

an associated posted message receiving unit configured to receive from the regional information distribution server a posted message associated with the location information of the mobile terminal among posted messages related to a region obtained by the regional information distribution server from a server for storing posted messages; and

a displaying unit configured to display the posted message received by the associated posted message receiving unit.

In another aspect of the present invention, there is provided a mobile terminal for displaying regional information, including:

a posted message obtaining unit configured to obtain posted messages related to a region from a server for storing posted messages;

a location information obtaining unit configured to obtain location information of the mobile terminal;

an associated posted message obtaining unit configured to obtain a posted message associated with the location information of the mobile terminal from the posted messages obtained by the posted message obtaining unit; and

a displaying unit configured to display the posted message obtained by the associated posted message obtaining unit.

In another aspect of the present invention, there is provided a regional information distribution system including a mobile terminal and a regional information distribution server for distributing regional information to the mobile terminal, the system including:

the regional information distribution server including

a posted message obtaining unit configured to obtain posted messages related to a region from a server for storing posted messages;

a location information receiving unit configured to receive location information of the mobile terminal from the mobile terminal;

an associated posted message obtaining unit configured to obtain a posted message associated with the location information of the mobile terminal from the posted messages obtained by the posted message obtaining unit; and

an associated posted message distributing unit configured to distribute the posted message obtained by the associated posted message obtaining unit to the mobile terminal; and

the mobile terminal including

a location information obtaining unit configured to obtain location information of the mobile terminal and transmit the location information to the regional information distribution server;

an associated posted message receiving unit configured to receive the posted message distributed from the regional information distribution server; and

a displaying unit configured to display the posted message received by the associated posted message receiving unit.

In another aspect of the present invention, there is provided a regional information distribution method in a regional information distribution server for distributing regional information to a mobile terminal, the method including the steps of:

obtaining posted messages related to a region from a server for storing posted messages;

receiving location information of the mobile terminal from the mobile terminal;

obtaining a posted message associated with the location information of the mobile terminal from the posted messages related to the region; and

distributing the posted message associated with the location information of the mobile terminal to the mobile terminal.

In another aspect of the present invention, there is provided a regional information display method in a mobile terminal for displaying regional information, the method including the steps of:

obtaining posted messages related to a region from a server for storing posted messages;

obtaining location information of the mobile terminal;

obtaining a posted message associated with the location information of the mobile terminal from the posted messages related to the region; and

displaying the posted message associated with the location information of the mobile terminal.

### Advantageous Effect of the Invention

According to one aspect of the present invention, it is possible for a user to easily select messages related to an interesting region among posted messages.

### BRIEF DESCRIPTION OF THE DRAWINGS

FIG. 1 shows a functional block diagram of a regional information distribution system in accordance with an embodiment of the present invention.

FIG. 2 shows an example of information stored in a hashtag information storage unit.

FIG. 3 shows an example of information stored in a railroad and road information storage unit.

FIG. 4 shows an example of information stored in a shop information storage unit.

FIG. 5 shows an example of information stored in a posted message storage unit.

FIG. 6 shows an example of information stored in a category information storage unit.

FIG. 7 shows an example of information stored in a location information storage unit.

FIG. 8 shows an example of information stored in a movement route information storage unit.

FIG. 9 shows first exemplary posted messages displayed in a displaying unit.

FIG. 10 shows second exemplary posted messages displayed in a displaying unit.

FIG. 11 shows third exemplary posted messages displayed in a displaying unit.

FIG. 12 shows a flowchart of a regional information distribution method in accordance with an embodiment of the present invention.

FIG. 13 shows an example of a movement route.

FIG. 14 shows an exemplary method of matching location information of a user with route information.

FIG. 15 shows a flowchart of a method of determining a transportation means in accordance with an embodiment of the present invention.

### DETAILED DESCRIPTION OF THE PREFERRED EMBODIMENTS

A regional information distribution server for distributing regional information to a mobile terminal in accordance with an embodiment of the present invention is described below.

The regional information distribution server obtains posted messages related to a region from a server for storing posted messages. For example, the regional information distribution server extracts posted messages which include location information, a hashtag, a name of a place, a name of a station, a name of a railroad, a name of a shop, or the like from the posted messages stored in the server. In addition, the regional information distribution server receives location information of a mobile terminal from the mobile terminal, obtains a posted message associated with the received location information, and distributes the posted message to the mobile terminal. For example, the posted message associated with the location information includes a posted message associated with the present location, a posted message associated with a frequently-visited place, and a posted message associated with a destination.

The regional information distribution server may group the posted messages into categories and distribute the posted message together with the category to the mobile terminal. For example, the regional information distribution server groups the posted messages into categories such as weather information (weather condition), road information (traffic jam information), railway traffic information, and gourmet information (restaurant review).

With the regional information distribution server, the mobile terminal can present only posted messages related to an interesting region or category to a user.

It should be noted that a mobile terminal in itself may collect regional information and display the regional information without using the regional information distribution server.

An embodiment of the present invention is described in detail below.

<Configuration of a Regional Information Distribution System>

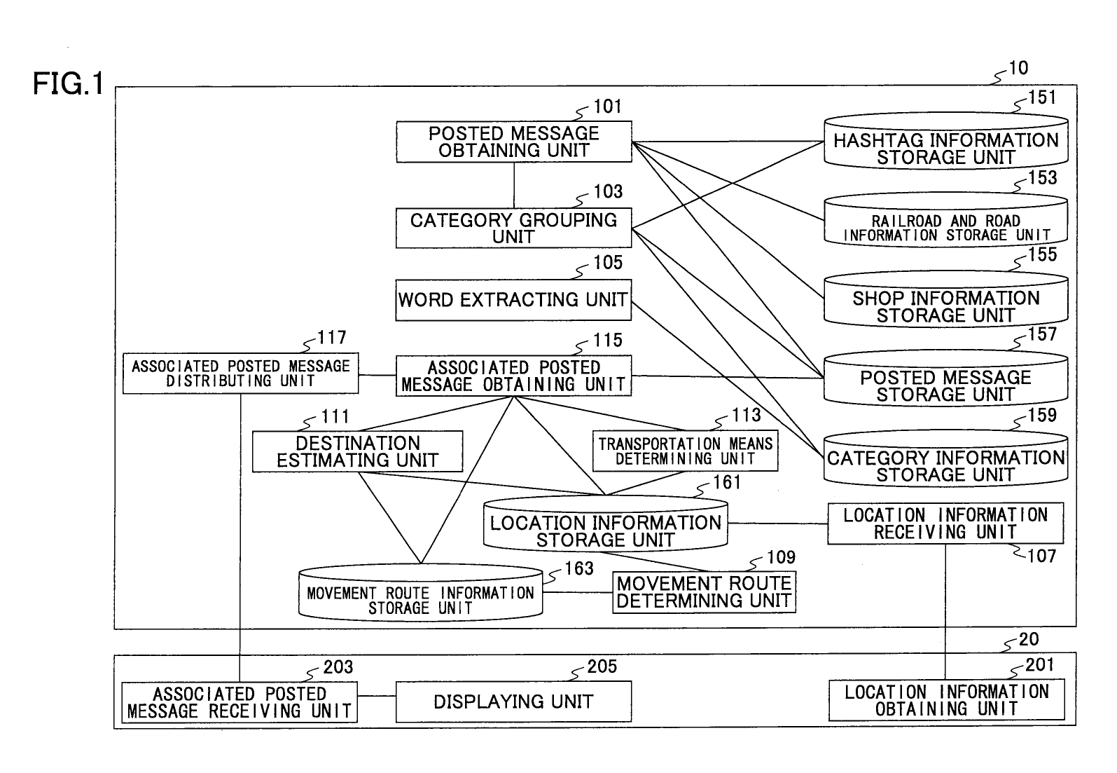

FIG. 1 shows a functional block diagram of a regional information distribution system in accordance with an embodiment of the present invention. The regional information distribution system includes a regional information distribution server 10 and a mobile terminal 20. The regional information distribution server 10 is a server connected to another server (not shown) for storing posted messages. The regional information distribution server 10 obtains posted messages from the server for storing posted messages and distributes a posted message related to a region to the mobile terminal 20. The mobile terminal 20 is a terminal including a positioning capability to obtain location information. The mobile terminal 20 includes a cellular phone, a smart phone, and so on.

The regional information distribution server 10 includes a posted message obtaining unit 101, a category grouping unit 103, a word extracting unit 105, a location information receiving unit 107, a movement route determining unit 109, a destination estimating unit 111, a transportation means determining unit 113, an associated posted message obtaining unit 115, an associated posted message distributing unit 117, a hashtag information storage unit 151, a railroad and road information storage unit 153, a shop information storage unit 155, a posted message storage unit 157, a category information storage unit 159, a location information storage unit 161, and a movement route information storage unit 163.

The mobile terminal 20 includes a location information obtaining unit 201, an associated posted message receiving unit 203, and a displaying unit 205.

The posted message obtaining unit 101 obtains posted messages related to a region from a server for storing messages posted by users on a message sharing website such as Twitter.

For example, the posted message obtaining unit 101 obtains posted messages to which location information is assigned. Location information obtained by GPS positioning, network positioning, or the like can be assigned to a posted message. When such location information is assigned to a posted message, the posted message obtaining unit 101 determines that the posted message corresponds to a posted message related to a region and obtains the posted message.

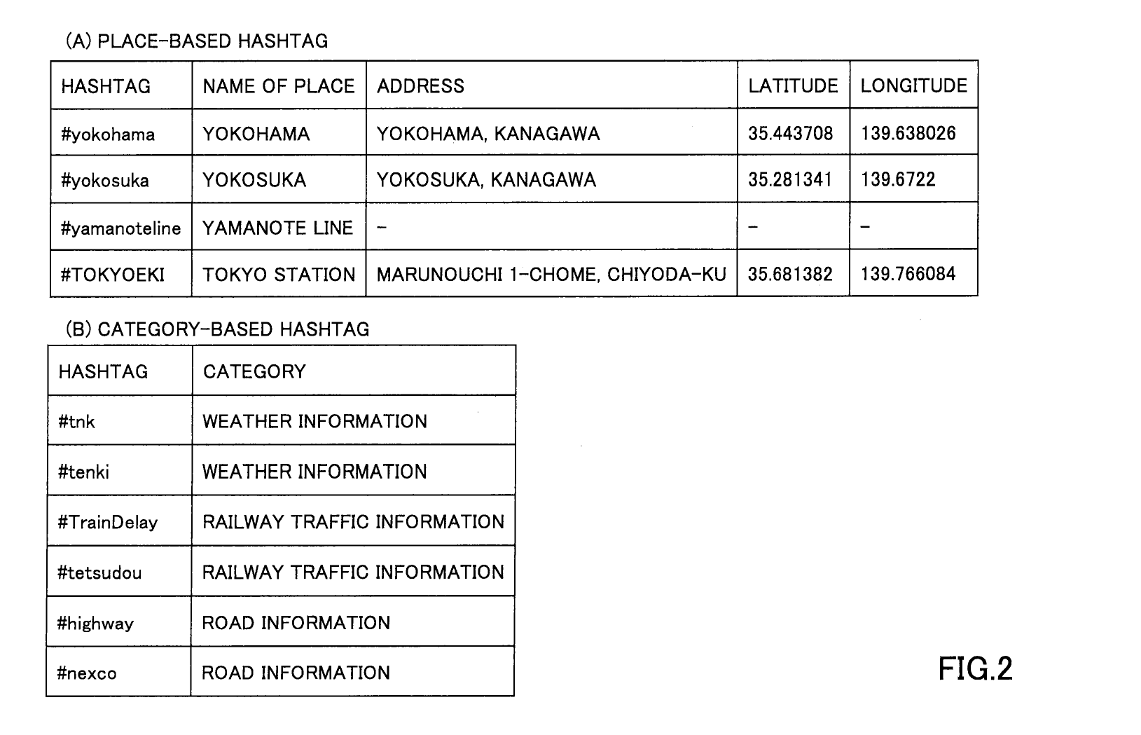

For example, the posted message obtaining unit 101 obtains posted messages which include place-based hashtags (for a name of a place) stored in the hashtag information storage unit 151 or posted messages including a name of a place. The hashtag represents a tag which a user can arbitrarily assign to a message in Twitter. FIG. 2(A) shows examples of place-based hashtags stored in the hashtag information storage unit 151. The hashtag information storage unit 151 stores a hashtag associated with a region and its location information. For example, a hashtag, a name of a place, an address, a latitude, and a longitude are stored in the hashtag information storage unit 151. FIG. 2(B) shows examples of category-based hashtags. The hashtag information storage unit 151 stores a hashtag and a category. Since a hashtag which is grouped into a predetermined category can be also related to a region, the category-based hashtag as well as the place-based hashtag may be used to obtain posted messages related to a region. The posted message obtaining unit 101 obtains a posted message when a hashtag assigned to the posted message includes one of the hashtags stored in the hashtag information storage unit 151. In addition, the posted message obtaining unit 101 obtains, by using text-matching, posted messages which include one of the places of the names stored in the hashtag information storage unit 151. The text-matching includes not only complete matching but also partial matching (the same applies to the following description).

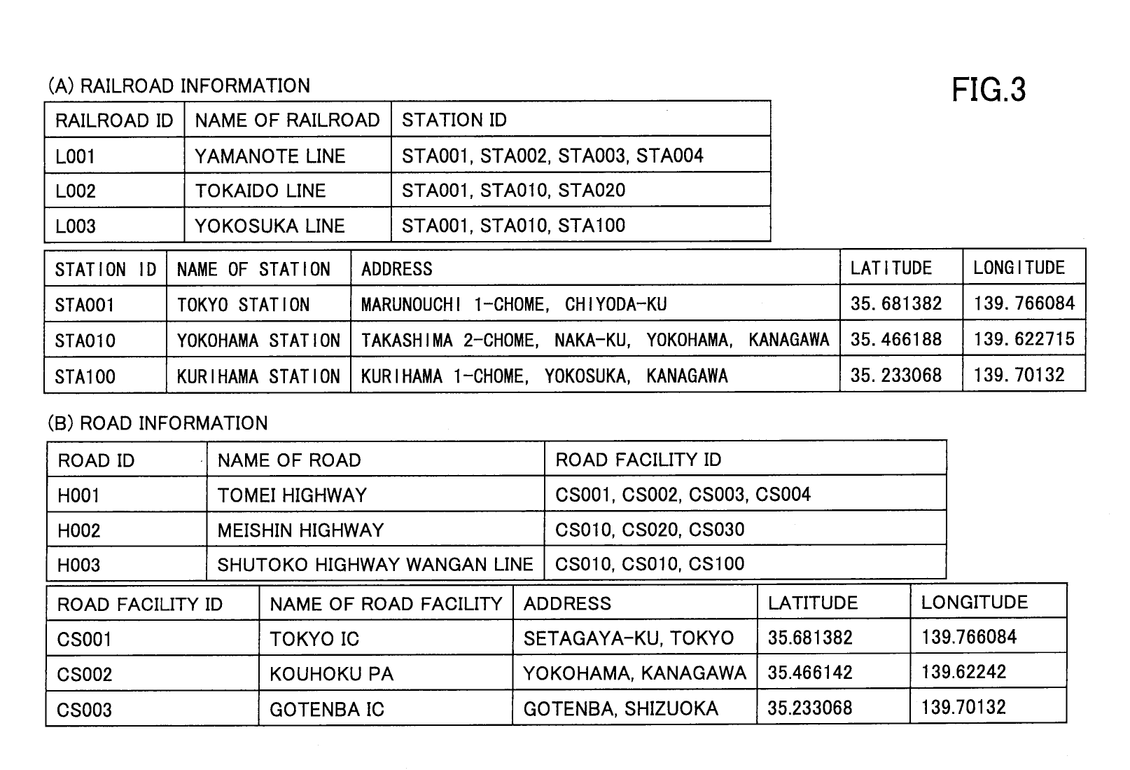

For example, the posted message obtaining unit 101 obtains posted messages which include one of names of stations, names of railroads, names of roads, or names of road facilities stored in the railroad and road information storage unit 153. FIG. 3 shows an example of railroad information and road information stored in the railroad and road information storage unit 153. The railroad and road information storage unit 153 stores a name of a railroad and stations on the railroad as railroad information. For example, a railroad ID, a name of a railroad, and station IDs are stored in the railroad and road information storage unit 153 as shown in FIG. 3(A). In addition, a station ID, a name of a station, an address, a latitude, and a longitude are stored as specific information for the station. The railroad and road information storage unit 153 stores a name of a road and facilities on the road as road information. For example, a road ID, a name of a road, and road facility IDs are stored in the railroad and road information storage unit 153 as shown in FIG. 3(B). In addition, a road facility ID, a name of a road facility, an address, a latitude, and a longitude are stored as specific information for the road facility. The posted message obtaining unit 101 obtains, by using text-matching, posted messages which include one of the names of the railroads, the names of the stations, the names of the roads, or the names of the road facilities stored in the railroad and road information storage unit 153.

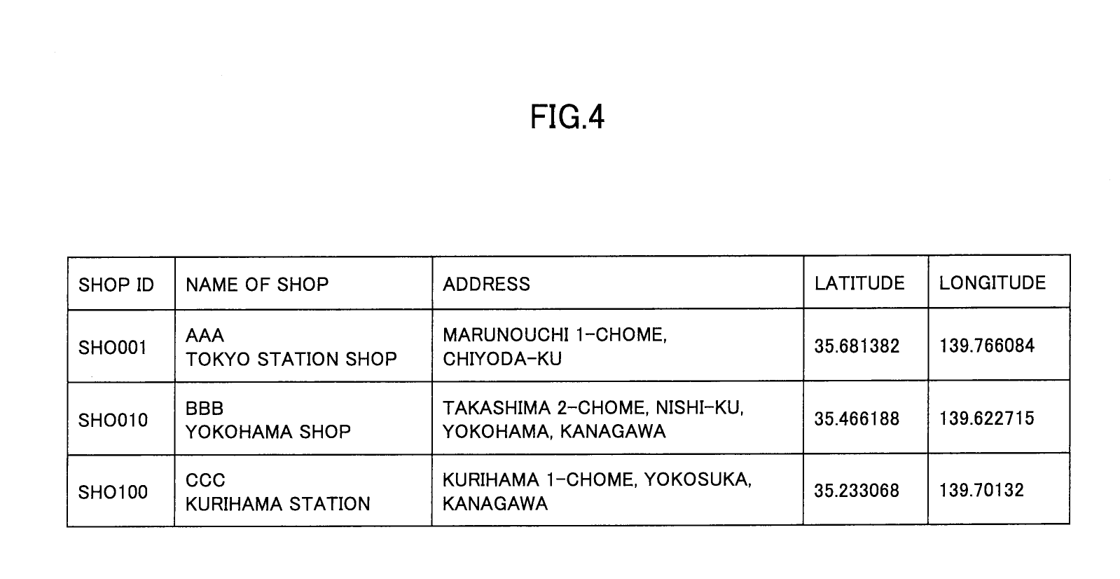

For example, a posted message obtaining unit 101 obtains posted messages which include a name of a shop stored in the shop information storage unit 155. FIG. 4 shows an example of shop information stored in the shop information storage unit 155. The shop information storage unit 155 stores a name of a shop and location information. For example, a shop ID, a name of a shop, an address, a latitude, and a longitude are stored in the shop information storage unit 155. The posted message obtaining unit 101 obtains, by using text-matching, posted messages which include one of the names of the shops stored in the shop information storage unit 155.

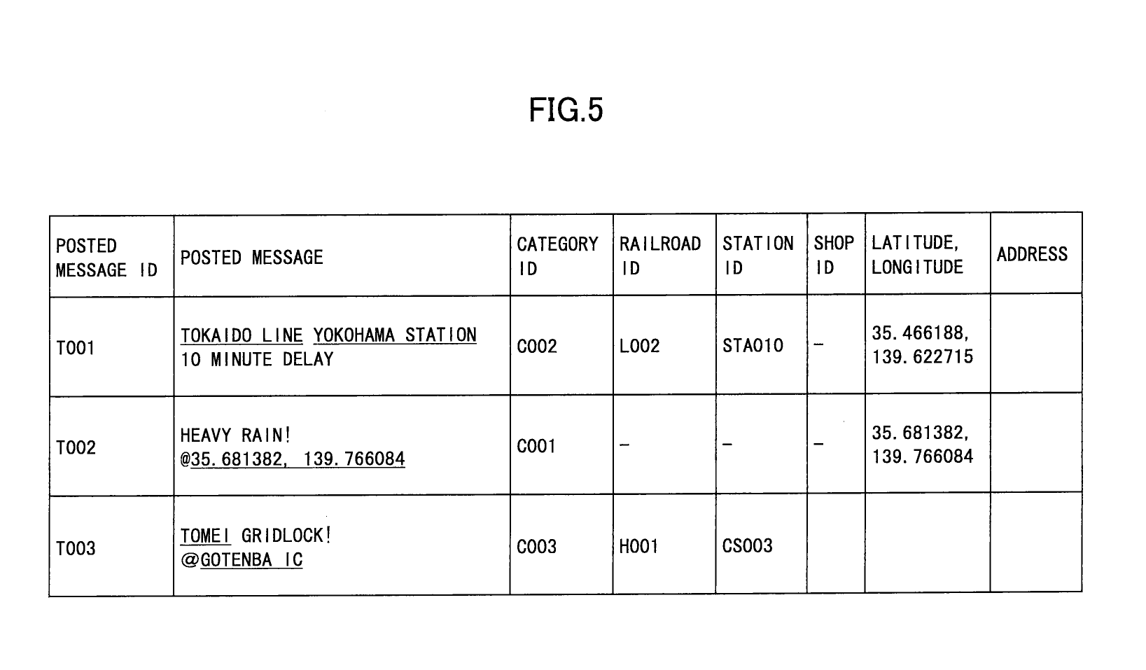

In this manner, the posted message obtaining unit 101 obtains posted messages related to a region and stores the obtained posted messages in the posted message storage unit 157. FIG. 5 shows examples of posted messages stored in the posted message storage unit 157. Posted messages are associated with a region and stored in the posted message storage unit 157. For example, a posted message ID, a posted message, a category ID, a railroad ID (or a road ID), a station ID (or a road facility ID), a shop ID, a latitude, a longitude, and an address are stored in the posted message storage unit 157. The posted message obtaining unit 101 sends posted message IDs to the category grouping unit 103.

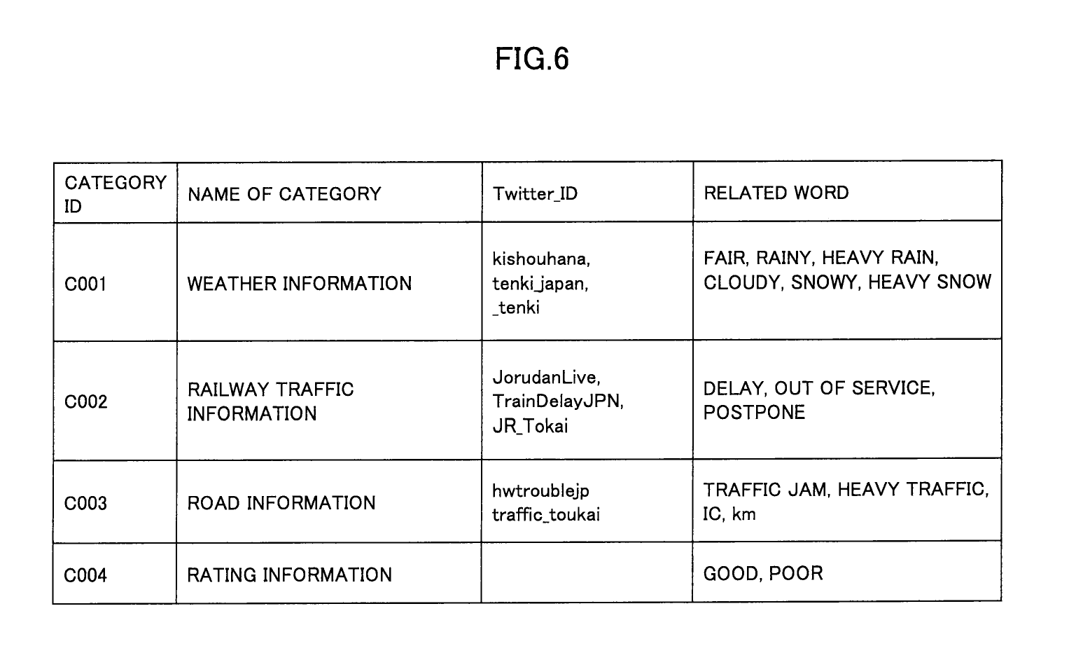

The category grouping unit 103 receives the posted message IDs from the posted message obtaining unit 101 and obtains the posted messages from the posted message storage unit 157. The category grouping unit 103 groups the posted messages into predetermined categories using information stored in the category information storage unit 159. FIG. 6 shows examples of categories stored in the category information storage unit 159. The category information storage unit 159 stores a name of a category, a user identification (Twitter_ID) associated with the category, and related words. The category grouping unit 103 groups a posted message into a category with a semantically shortest distance using the Twitter_ID or the related words.

For example, the category grouping unit 103 groups the posted messages into categories using Twitter_IDs. A Twitter_ID is assigned to the posted message in Twitter. For example, there are a Twitter_ID only used to post weather information, a Twitter_ID only used to post railway traffic information, and a Twitter_ID only used to post road information. When the Twitter_ID of the posted message matches one of Twitter_IDs stored in the category information storage unit 159, the category grouping unit 103 groups the posted message into the matching category.

For example, when the posted message includes one of the related words stored in the category information storage unit 159, the category grouping unit 103 groups the posted message into the corresponding category. For example, the category grouping unit 103 may generate semantic space vectors of categories using the related words as data for learning and group the posted message into a category with the highest degree of similarity to the semantic space vector of the posted message (for example, Noriyuki Wakatsuki, et. al., “Classification of Newspaper Articles using The Concept-Base and The Degree of Association between Concepts”, IPSJ SIG Notes, Information Processing Society of Japan, 2005-NL-165(10), Jan. 12, 2005).

For example, when a category-based hashtag is assigned to the posted message, the category grouping unit 103 may group the posted message into a category based on the relationship between the category-based hashtag and the category as shown in FIG. 2(B).

In this manner, the category grouping unit 103 groups posted messages into predetermined categories and stores category information in the posted message storage unit 157.

The word extracting unit 105 extracts related words corresponding to a category based on Twitter_IDs assigned to the posted messages, and stores the related words in the category information storage unit 159 as the related words for the category. For example, it is assumed that posted messages from Twitter_ID only used to post weather information include related words for weather information. Thus, the word extracting unit 105 extracts, as related words for weather information, words whose frequencies of appearance are above a predetermined threshold from the posted messages from Twitter_ID only used to post weather information, and then stores the words in the category information storage unit 159.

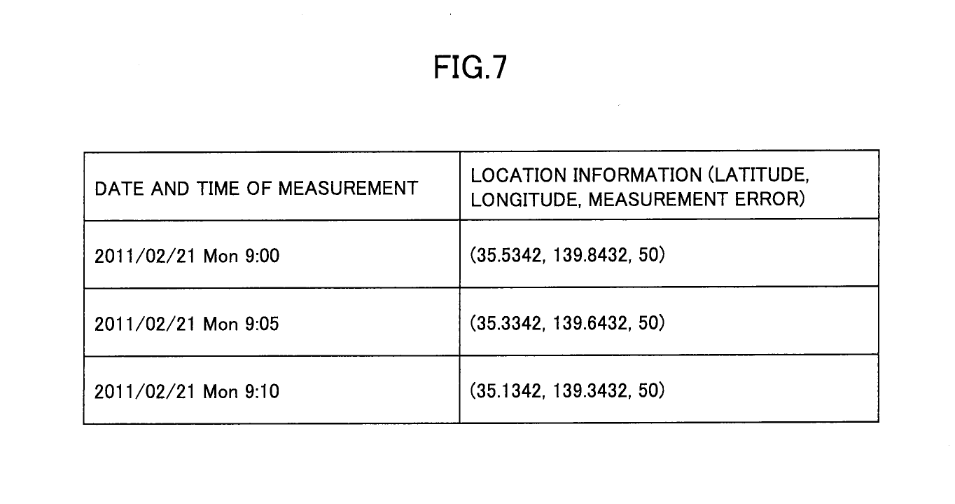

The location information receiving unit 107 receives location information measured by the mobile terminal 20 and stores the location information in the location information storage unit 161. FIG. 7 shows an example of location information stored in the location information storage unit 161. The location information storage unit 161 not only stores the latest location information but also previous location information within a predetermined time period. For example, the location information storage unit 161 stores a date and time of measurement and location information. The location information may include a measurement error.

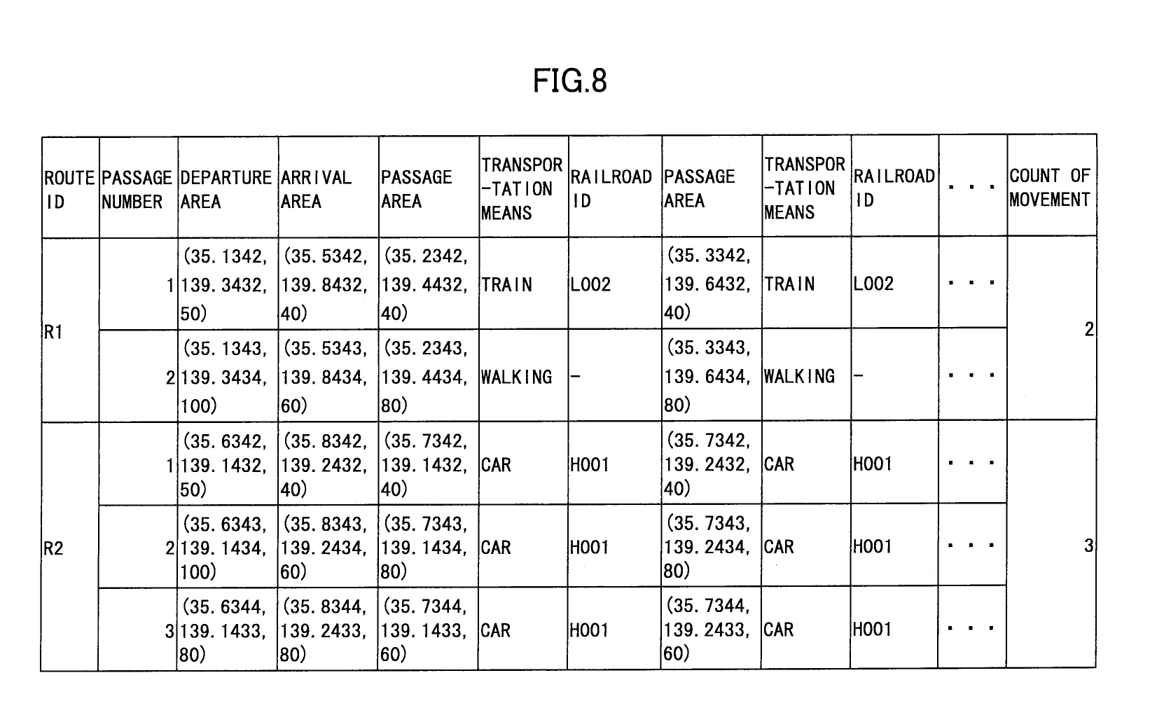

The movement route determining unit 109 obtains location information from the location information storage unit 161, determines a movement route of a user, and stores the determined movement route in the movement route information storage unit 163. FIG. 8 shows an example of route information stored in the movement route information storage unit 163. The movement route information storage unit 163 stores a passage number, a departure area, an arrival area, passage areas, transportation means, railroad IDs, and a count of movements for each movement route. The transportation means and the railroad ID are associated with each passage area.

Specifically, when a mobile terminal stays in a predetermined area, it is determined that the mobile terminal is in a stay state and the area is treated as a departure area. The departure area is expressed as a latitude, a longitude, and a measurement error of the departure location of the movement route. When the area of the mobile terminal changes, it is determined that the mobile terminal is in a movement state and the area is added to the passage areas. The passage area is expressed as a latitude, a longitude, and a measurement error of the passage location of the movement route. In addition, the passage area may be associated with a railroad ID (or a road ID) stored in the railroad and road information storage unit 153. Every time a passage area increases, a passage area, a transportation means, and a railroad ID (or a road ID) are added in the table shown in FIG. 8. When the mobile terminal becomes the stay state from the movement state, it is determined that the mobile terminal arrives at a destination and the area is added to the arrival area. The arrival area is expressed as a latitude, a longitude, and a measurement error of the arrival location of the movement route. When the same movement route is stored in the movement route information storage unit 163, the route information is stored by adding a new passage number and incrementing the count of movement. The movement route determining unit 109 is described in detail below.

The destination estimating unit 111 obtains the latest location information from the location information storage unit 161, and obtains a movement route which spatially overlaps the obtained location information from the movement route information storage unit 163. Specifically, when an area which overlaps the area of the obtained location information is stored in the movement route information storage unit 163, it is estimated that the mobile terminal moves along the movement route following the obtained location information and that the arrival area is treated as the destination of the user. One or more movement routes and destinations may be estimated together with probabilities that the mobile terminal moves along the movement routes. The destination estimating unit 111 sends the estimation result of the movement route and the destination to the associated posted message obtaining unit 115. The destination estimating unit 111 is described in detail below.

The transportation means determining unit 113 determines a transportation means of the user based on location information of the mobile terminal. The transportation means is a means of transportation used by the user to move and includes a train, a car, a bicycle, walking, and so on, for example. The transportation means determining unit 113 determines a movement speed of the user based on location information, and then determines whether the user is moving by a train, by a car, by a bicycle, or on foot based on the movement speed. Alternatively, the transportation means determining unit 113 may determine whether the user is moving by a train or by a car based on comparison with a route of a railroad or a road. The transportation means determining unit 113 stores the result of determining the transportation means in the movement route information storage unit 163 and sends the result to the associated posted message obtaining unit 115. The transportation means determining unit 113 is described in detail below.

The associated posted message obtaining unit 115 obtains a posted message associated with the location information of the mobile terminal, such as a posted message associated with the present location, the movement route, or the destination. Specifically, the associated posted message obtaining unit 115 obtains the latest location information (i.e., the present location of the mobile terminal) from the location information storage unit 161. In addition, the associated posted message obtaining unit 115 receives the estimated movement route and the estimated destination of the user from the destination estimating unit 111. The associated posted message obtaining unit 115 also obtains a posted message associated with location information which spatially overlaps the latest location information, the estimated movement route, and the estimated destination from the posted message storage unit 157. For example, the associated posted message obtaining unit 115 obtains from the posted message storage unit 157 a posted message associated with location information which is within a predetermined distance from the latitude and the longitude of the latest location information, the estimated movement route, or the estimated destination.

In addition, the associated posted message obtaining unit 115 obtains a transportation means of the user from the transportation means determining unit 113. When a category is assigned to the posted message, the associated posted message obtaining unit 115 determines a priority of the category based on the transportation means. For example, when the transportation means is a car, a posted message with a category of road information is prioritized. For example, when the transportation means is a train, a posted message with a category of railway traffic information is prioritized. For example, when the transportation means is a bicycle or walking, posted message with a category of weather information or gourmet information is prioritized.

In addition, the associated posted message obtaining unit 115 determines a priority of a posted message based on the distance from the latest location information (i.e., the present location of the mobile terminal). Specifically, the associated posted message obtaining unit 115 may prioritize a posted message associated with location information close to the present location of the mobile terminal along the movement route to the destination. When one or more movement routes and destinations are estimated, a priority may be determined based on the number of times that the mobile terminal has moved along the movement route (the count of movements stored in the movement route information storage unit 163).

The associated posted message distributing unit 117 distributes the posted message obtained by the associated posted message obtaining unit 115 to the mobile terminal 20. The associated posted message distributing unit 117 also distributes the category and the priority together with the posted message. Specifically, the associated posted message distributing unit 117 may only distribute a posted message when the distance to the latest location information is below a predetermined threshold or when the number of times that the mobile terminal has moved along the movement route is above a predetermined threshold.

The location information obtaining unit 201 obtains location information of the mobile terminal 20 by GPS positioning, network positioning, or the like and transmits the location information to the regional information distribution server 10.

The associated posted message receiving unit 203 receives the posted message related to the region, which is distributed by the associated posted message distributing unit 117. The associated posted message receiving unit 117 also receives the category and the priority together with the posted message.

The displaying unit 205 displays the received posted message.

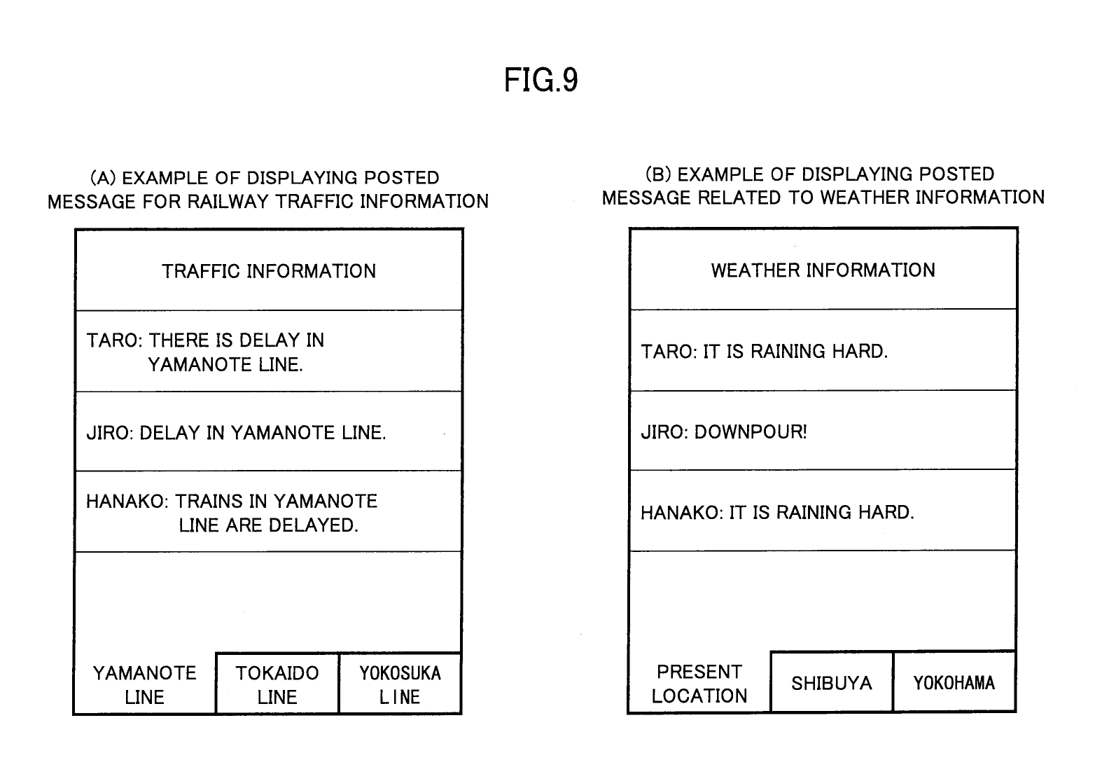

For example, the displaying unit 205 displays the posted message related to the present location, the movement route, and the destination of the user for each category, as shown in FIG. 9. FIG. 9(A) shows an example of displaying posted messages with the category of railway traffic information. The displaying unit 205 may display posted messages for each railroad through which a train passes by the present location. The displaying unit 205 may also display railway traffic information in descending order of the probability that the mobile terminal moves along the movement route (for example, in the order of Yamanote line, Tokaido line, and Yokosuka line). FIG. 9(B) shows an example of displaying posted messages with the category of weather information. The displaying unit 205 may display posted messages in ascending order of the distance from the present location. The displaying unit 205 may also display posted messages in ascending order of the distance from the present location along the movement route to the destination estimated by the destination estimating unit 111 (for example, in the order of the present location, Shibuya, and Yokohama).

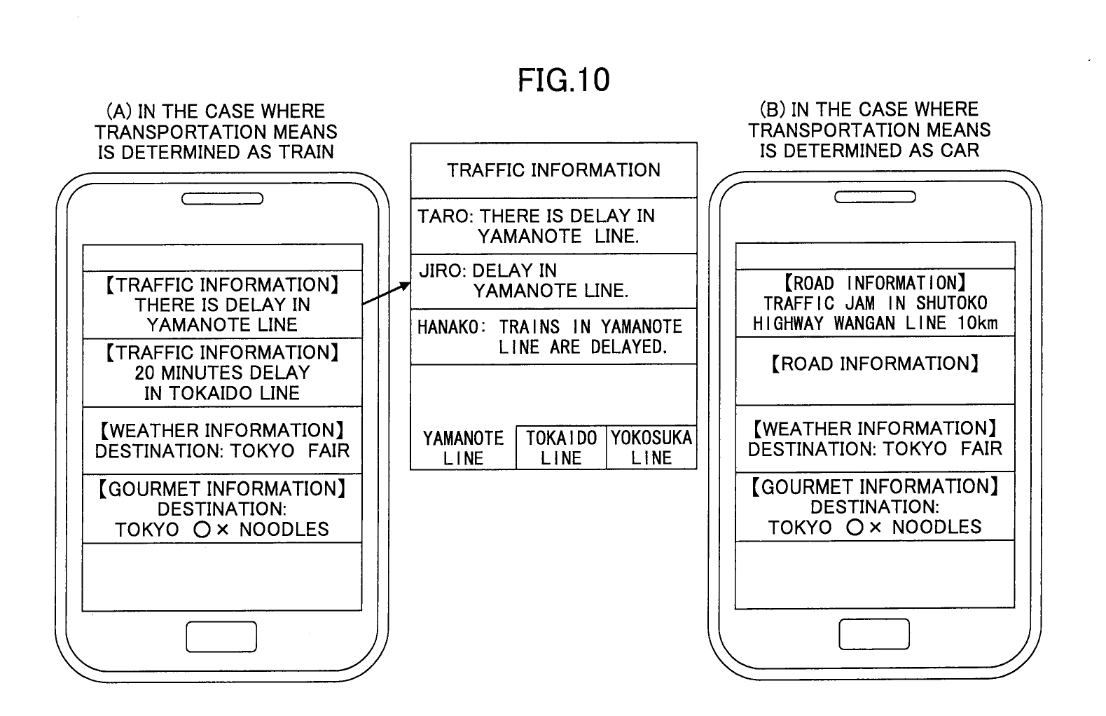

For example, the displaying unit 205 may prioritize the category to be displayed based on the transportation means, as shown in FIG. 10. For example, when the transportation means is determined as a train, the category of railway traffic information may be prioritized for display as shown in FIG. 10(A). When the railway traffic information is selected, detailed posted messages as shown in FIG. 9(A) may be displayed. For example, when the transportation means is determined as a car, the category of road information may be prioritized for display as shown in FIG. 10(B). For example, when the transportation means is determined as a bicycle or walking, the category of weather information or gourmet information may be prioritized for display. When the weather information is selected, detailed posted messages as shown in FIG. 9(B) may be displayed.

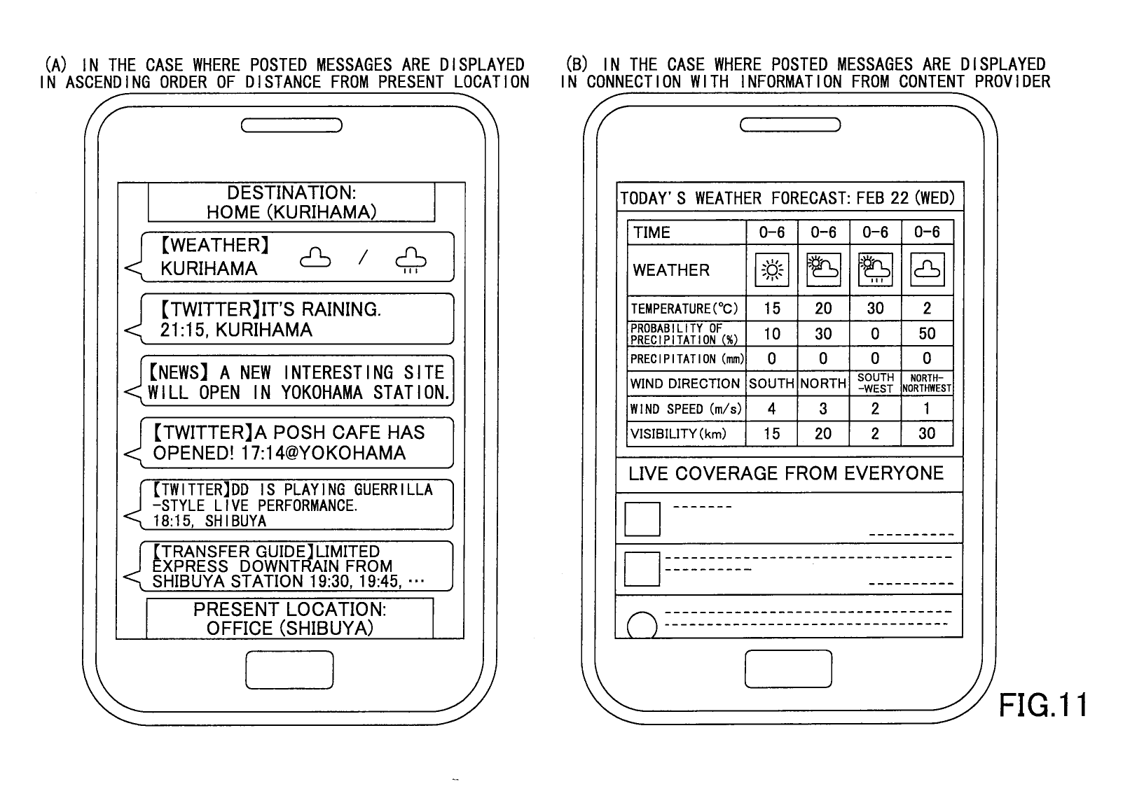

For example, the displaying unit 205 may display posted messages along the movement route from the present location to the destination as shown in FIG. 11(A). Although FIG. 11(A) shows that the posted messages with a plurality of categories are mixed and displayed, the posted messages displayed along the movement route may be grouped into categories.

There are content providers which provide contents such as weather information, railway traffic information, road information, and so on. Contents related to location information can be obtained by transmitting the location information to these content providers. For example, the displaying unit 205 may divide the display screen to display information from content providers on one portion of the screen and display posted messages on another portion of the screen.

For example, a mobile terminal such as a smart phone with a touch-sensitive panel for manipulations can display a screen (lock screen) for blocking touch manipulations to protect against an erroneous operation. The displaying unit 205 may display posted messages on the lock screen. This allows a user to check posted messages without unlocking the screen while the lock screen is displayed, thereby improving the convenience of the user.

<Flowchart of a Regional Information Distribution Method>

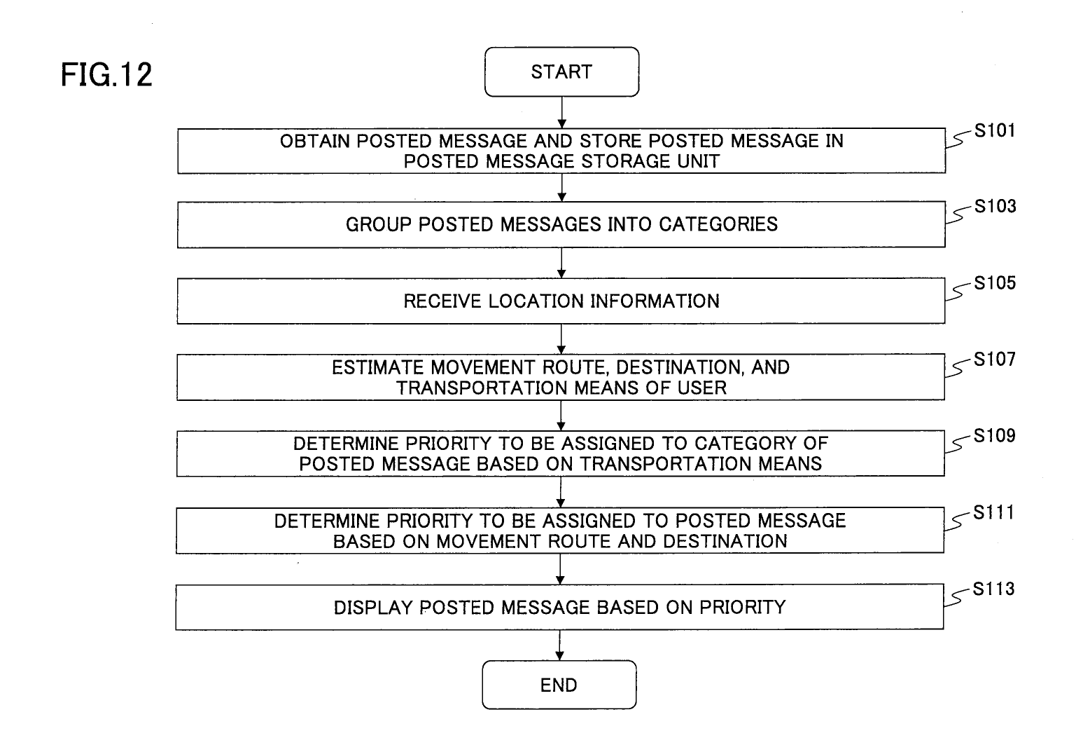

FIG. 12 shows a flowchart of a regional information distribution method in accordance with an embodiment of the present invention.

First, the posted message obtaining unit 101 obtains posted messages related to a region and stores the posted messages in the posted message storage unit 157 (step S101). As shown in FIG. 5, for example, the name of the railroad and the name of the station in the posted message “Tokaido line, Yokohama station, 10 minute delay” includes “Tokaido line” and “Yokohama station” stored in the railroad and road information storage unit 153. Thus, the posted message obtaining unit 101 associates this posted message with the railroad ID of Tokaido line, the station ID of Yokohama station, and the latitude and the longitude of Yokohama station and stores the posted message in the posted message storage unit 157. For example, location information is assigned to the posted message “Heavy rain! @35.618382, 139.766084”. Thus, the posted message obtaining unit 101 associates this posted message with the latitude and the longitude (35.681382, 139.766084) and stores the posted message in the posted message storage unit 157. For example, the name of the road and the name of the road facility in the posted message “Tomei, gridlock! @Gotenba IC” partially includes “Tomei highway” and “Gotenba IC” stored in the railroad and road information storage unit 153. Thus, the posted message obtaining unit 101 associates this posted message with the road ID (railroad ID) of Tomei highway and the facility ID (station ID) of Gotenba IC and stores the posted message in the posted message storage unit 157.

Then, the category grouping unit 103 groups the posted messages into categories and stores the categories in the posted message storage unit 157 (step S103). In FIG. 5, for example, the posted message “Tokaido line, Yokohama station, 10 minute delay” includes the related word “delay” stored in the category information storage unit 159. Thus, the category grouping unit 103 groups this posted message into “railway traffic information”, assigns the category ID to the posted message, and stores the category information in the posted message storage unit 157. For example, the posted message “Heavy rain! @35.618382, 139.766084” includes the related word “heavy rain” stored in the category information storage unit 159. Thus, the category grouping unit 159 groups this posted message into “weather information”, assigns the category ID to the posted message, and stores the category information in the posted message storage unit 157. For example, the posted message “Tomei, gridlock! @Gotenba IC” includes “gridlock” which is semantically similar to the related word “heavy traffic”. Thus, the category grouping unit 103 groups this posted message into “road information”, assigns the category ID to the posted message, and stores the category information in the posted message storage unit 157.

Then, the location information receiving unit 107 receives location information measured by the mobile terminal 20 and stores the location information in the location information storage unit 161 (step S105). For example, location information within a predetermined time period is stored in the location information storage unit 161, as shown in FIG. 7. In addition, the destination estimating unit 111 estimates the movement route and the destination of the user and the transportation means determining unit 113 determines the transportation means of the user (step S107). As shown in FIG. 7, since the latest location information is (35.1342, 139.3432, 50), this location information corresponds to the departure area of the movement route R1 stored in the movement route information storage unit 163. Thus, the destination estimating unit 111 can estimate the arrival area and the passage area. Furthermore, the transportation means determining unit 113 determines that the transportation means is a train.

Then, the associated posted information obtaining unit 115 determines a priority to be assigned to the category of the posted message based on the transportation means (step S109). Since the transportation means is determined as a train in this example, posted messages with the category of railway traffic information are prioritized. In addition, the associated posted message obtaining unit 115 determines a priority to be assigned to the posted message based on the movement route and the destination (step S111). Since the destination estimating unit 111 estimates that the mobile terminal arrives at the destination along the route (35.1342, 139.3432, 50)->(35.2342, 139.4432, 40)->(35.3342, 139.6432, 40)-> . . . ->(35.5342, 139.8432, 50), the associated posted message obtaining unit 115 determines the priority of the posted message in each area along the movement route in ascending order of the distance from the latest location information.

Then, the set of information (posted messages) is delivered to the mobile terminal 20 and the displaying unit 205 of the mobile terminal 20 displays the posted messages based on the priorities (step S113). For example, the posted messages are displayed as shown in FIGS. 9-11.

Although the regional information distribution system using the regional information distribution server and the mobile terminal is described in the embodiment of the present invention, the present invention can be implemented only in the mobile terminal. In this case, the mobile terminal includes all the functional blocks except for the location information receiving unit 107, the associated posted message distributing unit 117, and the associated posted message receiving unit 203 among the functional blocks shown in FIG. 1. Alternatively, any function distribution can be possible between the regional information distribution server and the mobile terminal.

<Detailed Description of a Movement Route Determining Unit and a Destination Estimating Unit>

Next, the movement route determining unit 109 and the destination estimating unit 111 are described in detail below.

As shown in FIG. 8, the movement route information storage unit 163 stores information (a route ID, a passage number, a departure area, an arrival area, passage areas, transportation means, railroad IDs, and a count of movement) about each previous movement route along which the mobile terminal has moved. The route ID (for example, “R1” and “R2”, hereinafter referred to as a “movement route R1” and a “movement route R2”) is an identifier for identifying the movement route along which the mobile terminal has moved. The passage number is an identifier for each movement route corresponding to the route ID. The departure area is area information about the departure area (the area including the starting point (departure point) of the movement route) of each movement route corresponding to the route ID. The arrival area is area information about the arrival area (the area including the termination point (arrival point) of the movement route) of each movement route corresponding to the route ID. Each of the departure area, the arrival area, and the passage area may include a time at which the mobile terminal has passed through the area.

The passage area is area information about the passage area (except for the departure area and the arrival area) through which the mobile terminal has passed along each movement route. The transportation means is a transportation means by which the mobile terminal has passed through the passage area. The railroad ID is an ID of the railroad or the road along which the mobile terminal has passed through the passage area. The count of movements is the number of times that the mobile terminal has moved along each movement route corresponding to the route ID.

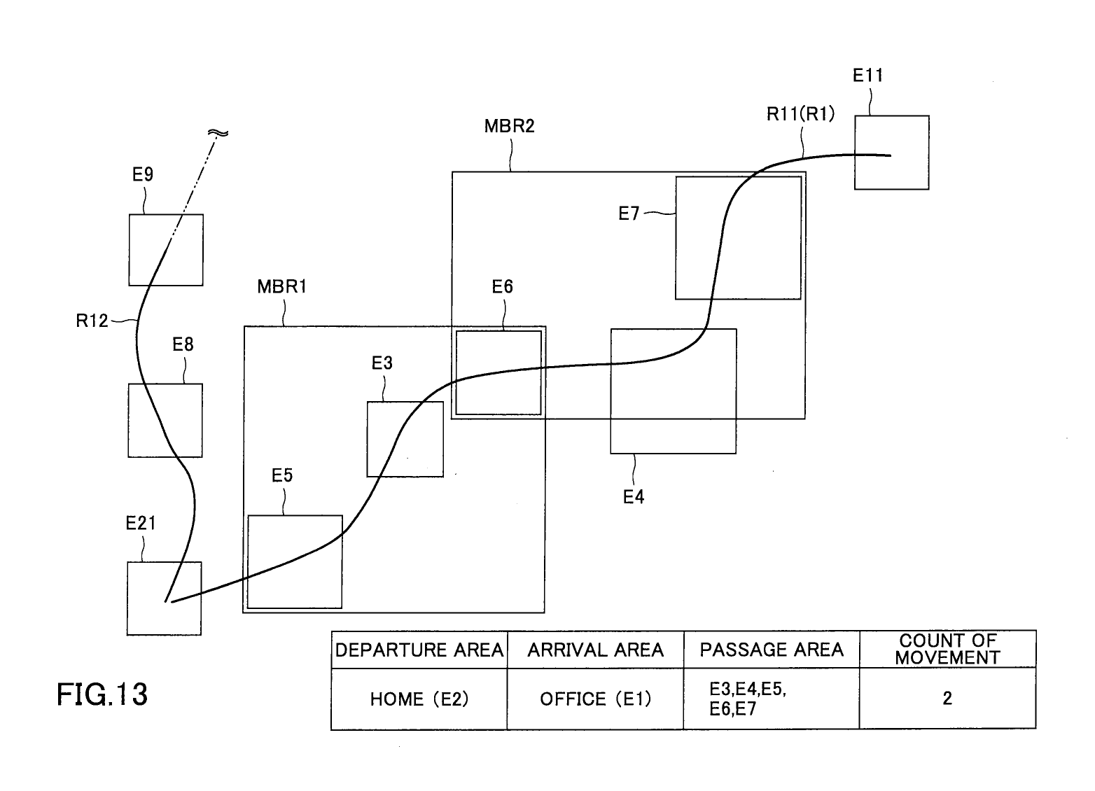

The movement route determining unit 109 detects the present area information of the mobile terminal at a predetermined time period. Specifically, the movement route determining unit 109 detects the area (for example, an area expressed as a square, twice the size of the measurement error on a side, centered at the latitude and the longitude of the present location of the mobile terminal) within which the mobile terminal is situated and the time of the detection at a predetermined time period (for example, every five minutes or every ten minutes) based on location information (for example, a GPS signal indicating the latitude and the longitude of the present location of the mobile terminal) of the mobile terminal stored in the location information storage unit 161. With reference to FIG. 13, specifically, the movement route determining unit 109 sequentially detects new areas E21, E3, E4, and E11 (areas within which the mobile terminal has been situated), for example. The areas E5, E6, and E7 have been detected and already stored in the movement route information storage 163 as shown in FIG. 8. In FIG. 13, the areas E21 and E11 respectively correspond to the departure area E2 and the arrival area E1 which have been already detected.

The movement route determining unit 109 detects a new movement route of the mobile terminal based on the detected area information. The movement route determining unit 109 detects a movement route along which the mobile terminal is moving based on the detected areas (the area within which the mobile terminal has been situated). With reference to FIG. 13, specifically, the movement route determining unit 109 detects a new movement route R11 along which the mobile terminal is moving based on the detected areas E21, E3, E4, and E11. The movement route determining unit 109 detects whether the mobile terminal is in the stay state or in the movement state as follows. When the movement route determining unit 109 sequentially detects a first area and a second area which overlap each other and have a common area between the first area and the second area, and then when the movement route determining unit 109 sequentially detects the first area, . . . , an n-th area (n is a predetermined positive integer) which have a common area, the movement route determining unit 109 detects that the mobile terminal is in the stay state. Otherwise, the movement route determining unit 109 detects that the mobile terminal is in the movement state.

In addition, the movement route determining unit 109 determines the railroad ID (or road ID) in the passage area. When the transportation means determining unit 113 determines that the transportation means is a train, the movement route determining unit 109 refers to railroads to associate the passage area with a railroad ID. When the transportation means determining unit 113 determines that the transportation means is a car, the movement route determining unit 109 refers to roads to associate the passage area with a road ID. When the transportation means determining unit 113 determines that the transportation means is a bicycle or walking, the movement route determining unit 109 also refers to roads to associate the passage area with a road ID.

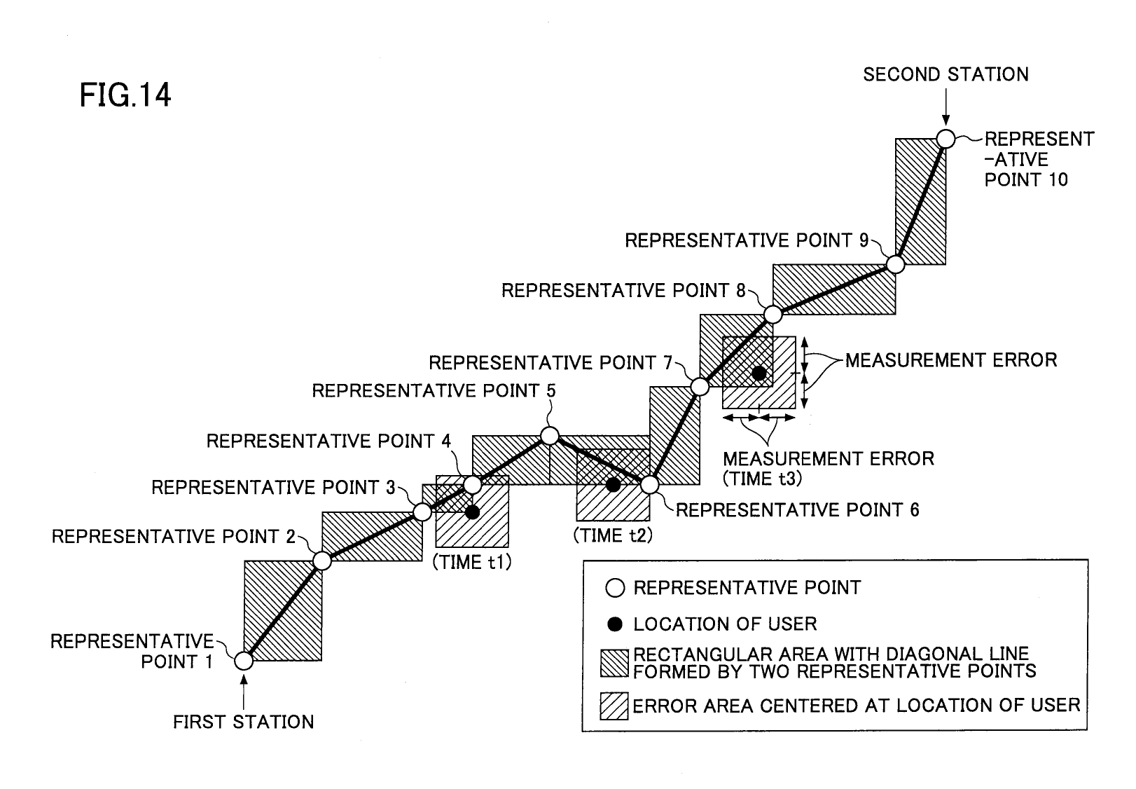

FIG. 14 shows that a route from a first station to a second station of the routes stored in the railroad and road information storage unit 153 is specified by position coordinates of ten representative points including both ends. Any number of representative points may be used. FIG. 14 also shows a first rectangular area with a diagonal line formed by adjacent representative points. It also shows a second rectangular area expressed as a square, twice the size of the measurement error on a side, centered at the position coordinates of the user. When the first rectangular area and the second rectangular area at least partially overlap each other, it is determined that the user has been situated around the area. Specifically, when the cumulative amount of the overlap (the area of the overlap or the number of times that the first and second rectangular areas overlap) between the first rectangular area and the second rectangular area along the route is above a predetermined threshold, it can be determined that the user has been using the railroad (or the road). Then, the movement route determining unit 109 associates the passage area with the railroad ID (or the road ID).

Although the first rectangular area is defined by the diagonal line formed by adjacent representative points, this is not essential for the present invention. Alternatively, the first rectangular area may be defined by the diagonal line formed by two non-adjacent representative points. Preferably, the length of the diagonal line of the first rectangular area is shorter in view of accurately determining the amount of movement along the route when there are many houses and roads near the route.

Although the amount of the overlap or the number of times that the first and second rectangular areas overlap is determined in the example shown in FIG. 14, the use of the rectangular areas is not essential for the present invention. For example, an overlap between a first circular area with a diameter formed by two representative points and a second circular area with a radius of the measurement error and centered at the location of the user may be determined along the route. To put it briefly, it is enough just to determine whether the user has been situated near the route.

The destination estimating unit 111 determines whether the new movement route corresponds to the previous movement route based on the areas included in area information of the new movement route and the areas included in area information of the previous movement route. The destination estimating unit 111 may determine whether the new movement route corresponds to the previous movement route based on whether a predetermined number of areas included in the area information of the new movement route overlap one or more areas included in the area information of the previous movement route. Based on the movement route information storage unit 163, the destination estimating unit 111 may also determine whether the detected new (present) movement route corresponds to the previous movement route stored in the movement route information storage unit 163. With reference to FIGS. 8 and 13, specifically, the destination estimating unit 111 determines whether the detected new movement route R11 corresponds to the previous movement route stored in the movement route information storage unit 163.

The destination estimating unit 111 determines, in the order of movement for each passage area along the new movement route, whether the passage area through which the mobile terminal has passed along the new movement route overlaps a predetermined number N2 (for example, two) of passage areas included in one of the previous movement routes which is closest to the passage area and stored in the movement route information storage unit 163. Except when the destination estimating unit 111 determines that there is successively no common area in a predetermined number N3 (for example, two) or more of passage areas along the new movement route, the destination estimating unit 111 determines that the new moment route corresponds to one of the previous movement routes stored in the movement route information storage unit 163.

With reference to FIGS. 8 and 13, the destination estimating unit 111 is described in detail below. The destination estimating unit 111 determines whether the passage area (area E3) through which the mobile terminal has passed along the new movement route R11 overlaps a minimum rectangular area MBR1 (specifically, including areas E5 and E6) which includes a predetermined number N2 (equal to two) of passage areas (the areas E5 and E6 which are closest to the area E3) closest to the area E3 and included in the previous movement route R1 stored in the movement route information storage unit 163. The destination estimating unit 111 also determines whether the passage area (area E4) through which the mobile terminal has passed along the new movement route R11 overlaps a minimum rectangular area MBR2 (specifically, including areas E6 and E7) which includes a predetermined number N2 (equal to two) of passage areas (the areas E6 and E7 which are closest to the area E4) which are closest to the area E4 and included in the previous movement route R1 stored in the movement route information storage unit 163. Since the area E3 is included in the MBR1 and the area E4 overlaps the MBR2, the destination estimating unit 111 determines that both of the areas E3 and E4 include a common area. Thus, the destination estimating unit 111 determines that the new movement route R11 corresponds to the previous movement route R1 including the areas E5, E6, and E7.

The departure area of the new movement route determined by the destination estimating unit 111 as corresponding to the previous movement route stored in the movement route information storage unit 163 corresponds to either the departure area or the arrival area of the previous movement route. The fact that two areas correspond to each other means two areas overlap each other and there is a common area between the two areas. With reference to FIG. 13, specifically, the departure area (area E21) of the new movement route R11 corresponds to the departure area (area E2 “home” (FIG. 13)) of the previous movement route R1. Thus, the destination estimating unit 111 identifies the previous movement route R1 including the departure area (area E2 “home” (FIG. 13)) which corresponds to the departure area (area E21) of the new movement route R11. Then, the destination estimating unit 111 determines that there is a common area between the area E3 through which the mobile station has first passed and the MBR1 including the passage areas (areas E5 and E6) of the movement route R1, and accordingly determines that the mobile terminal is moving along the previous movement route R1. Further, the destination estimating unit 111 determines that there is a common area between the area E4 through which the mobile station has first passed after the area E3 and the MBR2 including the passage areas (areas E6 and E7) of the movement route R1, and accordingly also determines that the mobile terminal is moving along the same previous movement route R1 as determined in the area E3, through which the mobile station has passed immediately before the area E4.

When the movement route determining unit 109 determines that the mobile terminal changes from the movement state to the stay state and the destination estimating unit 111 determines that the new movement route corresponds to the previous movement route stored in the movement route information storage unit 163, the movement route determining unit 109 adds area information (including each of the departure area, the arrival area, and the passage area of the new movement route) to area information of the previous movement route stored in the movement route information storage unit 163. In addition, the movement route determining unit 109 increments and updates the count of movements stored in the movement route information storage unit 163. When the destination estimating unit 111 determines that the new movement route does not correspond to the previous movement route stored in the movement route information storage unit 163, the movement route determining unit 109 stores, as new movement route information, area information (including the departure area, the arrival area, and the passage area of the new movement route) of the new movement route in the mobile route information storage unit 163.

With reference to FIG. 13, the movement route determining unit 109 is described in detail below. When the destination estimating unit 111 determines that the new movement route R11 corresponds to the previous movement route R1, the movement route determining unit 109 adds area information (including each of the departure area, the arrival area, and the passage area of the new movement route R11) to area information of the movement route R1 in the movement route information storage unit 163.

When the movement route determining unit 109 detects a new movement route R12 based on detected areas E8 and E9 and the destination estimating unit 111 determines that the new movement route R12 does not correspond to the previous movement route stored in the movement route information storage unit 163, the movement route determining unit 109 stores information (including each of the departure area, the arrival area, and the passage area of the new movement route R12) about the new movement route R12 in the movement route information storage unit 163 as new movement route information. For example, the destination estimating unit 111 determines that there is no common area between the area E8 along the new movement route R12 and the minimum rectangular area (for example, MBR1) which includes a predetermined number N2 (equal to two) of passage areas which are closest to the area E8. The destination estimating unit 111 further determines that there is no common area between the area E9 along the new movement route R12 and the minimum rectangular area (for example, MBR1) which includes a predetermined number N2 of passage areas along the new movement route R1 which are closest to the area E9. Accordingly, the destination estimating unit 111 determines that there is no common area in a predetermined number N3 (equal to two) or more of passage areas (areas E8 and E9) along the new movement route R12, and finally determines that the new movement route R12 does not corresponds to the previous movement route R1 stored in the movement route information storage unit 163.

Then, the destination estimating unit 111 calculates the probability that the mobile terminal moves along the previous movement route based on the determined previous movement route and the count of movement, and estimates an area to be visited after the present area of the mobile terminal based on the calculated probability. The destination estimating unit 111 may identify a plurality of areas as candidates for areas to be visited, extract a previous movement route passing through each candidate for an area to be visited, calculate a probability of passing through the candidate for the area by the sum of the probabilities that the mobile station moves along the respective previous movement routes, and estimate the area with the maximum probability of passing through the area as the area to be visited. When there is no corresponding previous movement route, the destination estimating unit 111 may suspend the estimation of the area to be visited, and resume the estimation at the time when a corresponding previous movement route is found by the detection of the new movement route.

<Detailed Description of a Transportation Means Determining Unit>

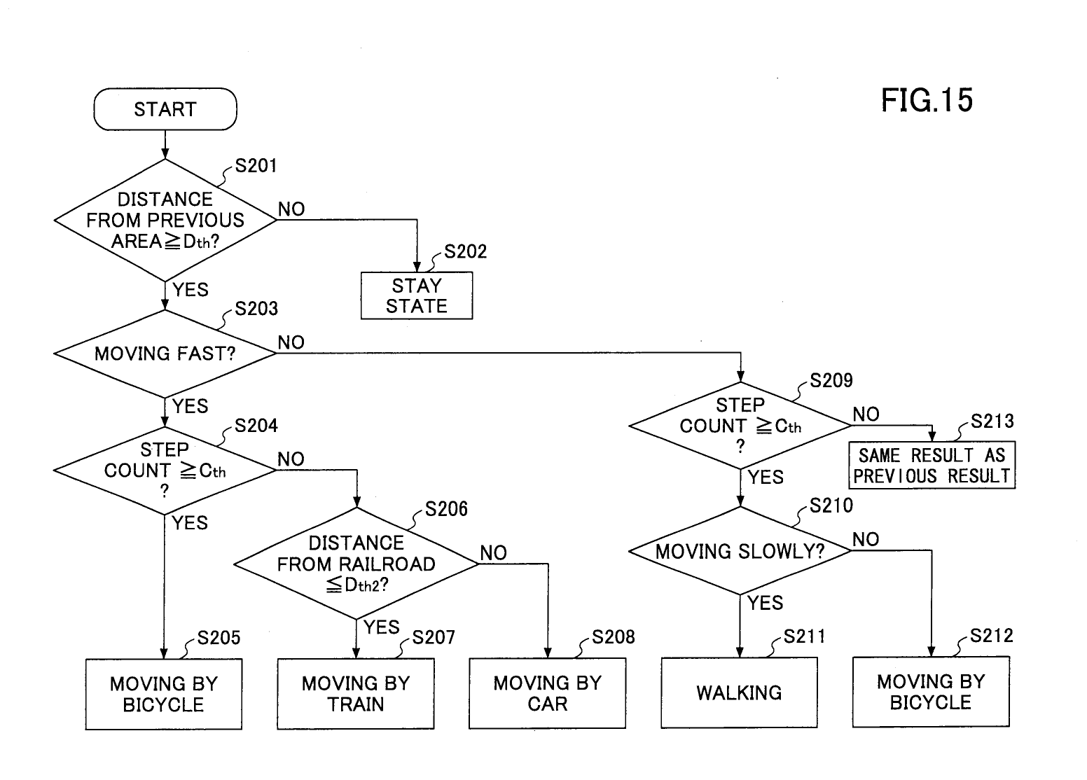

Next, with reference to FIG. 15, the transportation means determining unit 113 is described in detail below. In order to accurately determine a transportation means, the transportation means determining unit 113 may use location information of the user as well as step count information. The transportation means is a means of transportation used by the user to move and includes a train, a car, a bicycle, walking, and so on, for example.

First, the transportation means determining unit 113 assumes that the initial state of the transportation means of the user is walking. Then, the transportation means determining unit 113 determines whether the distance between the area which has been estimated based on location information with the minimum measurement error among the areas in the stay state and the area within which the user is estimated to be situated is above Dₜₕ meters (S201). The length of Dₜₕ meters is a minimum distance which can be used to determine that the user has moved. Dₜₕ is determined in advance. When the distance between the area which has been estimated based on location information with the minimum measurement error among the areas in the stay state and the area within which the user is estimated to be situated is below Dₜₕ meters, the transportation means determining unit 113 estimates that the user is in the stay state (S202).

When the distance between the area which has been estimated based on location information with the minimum measurement error among the areas in the stay state and the area within which the user is estimated to be situated is above Dₜₕ meters, the transportation means determining unit 113 determines whether the movement speed of the user is above Vₜₕ km/h for a time period of Tₜₕ₁ minutes or more (S203). The speed of Vₜₕ km/h is faster than a typical walking speed (for example, 3-4 km/h) and is preferably about a typical cycling speed (15-20 km/h). The time period of Tₜₕ₁ minutes may be any time period within which it can be determined that the user is using the transportation means. The time period of Tₜₕ₁ minutes may be twice or three times as long as the duration of obtaining location information of the user. Tₜₕ₁ and Vₜₕ are determined in advance. The movement speed of the user can be calculated based on successively obtained location information of the user. For example, using location information p₁ of the user obtained at the time t₁ and location information p₂ of the user obtained at the time t₂, the movement speed of the user can be calculated by dividing the distance between p₁ and p₂ by the time period (t₂−t₁).

In step S203, when it is determined that the movement speed of the user is above Vₜₕ km/h for the time period of Tₜₕ₁ minutes or more, it is determined that the step count is above a predetermined threshold Cₜₕ (S204). Cₜₕ may be any value (for example, about 50) larger than the step count calculated when the user uses a train or a car. Cₜₕ is determined in advance. When it is determined that the step count is above Cₜₕ, the transportation means determining unit 113 estimates that the user is moving by a bicycle (S205). When it is determined that the step count is below Cₜₕ, the transportation means determining unit 113 determines whether the distance between the area within which the user is estimated to be situated and the route of the railroad is below Dₜₕ₂ meters (S206). The length of Dₜₕ₂ meters may be any distance which can be used to estimate that the user is moving along the route of the railroad. Dₜₕ₂ is determined in advance. When the distance from the route of the railroad is below Dₜₕ₂ meters, the transportation means determining unit 113 determines that the user is moving by a train (S207). When the distance from the route of the railroad is above Dₜₕ₂ meters, on the other hand, the transportation means determining unit 113 determines that the user is moving by a car (S208).

In step S203, when it is determined that the movement speed of the user is not above Vₜₕ km/h for the time period of Tₜₕ₁ minutes or more, it is determined whether the step count is above the predetermined threshold Cₜₕ (S209). When it is determined that the step count is above Cₜₕ, the transportation means determining unit 113 determines whether the movement speed of the user is below Vₜₕ₂ km/h for a time period of Tₜₕ₂ minutes or more (S210). The speed of Vₜₕ₂ km/h is slower than Vₜₕ km/h and preferably between a typical walking speed (for example, 3-4 km/h) and typical cycling speed (for example, 15-20 km/h). Similar to Tₜₕ₁ minutes, Tₜₕ₂ minutes may be any time period within which it can be determined that the user is using the transportation means. Tₜₕ₂ minutes may be about 1-2 minutes. Tₜₕ₂ and Vₜₕ₂ are determined in advance. When it is determined that the movement speed of the user is below Vₜₕ₂ km/h for the time period of Tₜₕ₂ minutes or more, the transportation means determining unit 113 estimates that the user is walking (S211). When it is determined that the movement speed of the user is not below Vₜₕ₂ km/h for the time period of Tₜₕ₂ minutes or more, the transportation means determining unit 113 estimates that the user is moving by a bicycle (S212). When it is determined that the step count is below the predetermined threshold Cₜₕ, no transportation means can be determined. Thus, the previously estimated transportation means is used as the transportation means of the user (S213).

### Effects of Embodiments

According to an embodiment of the present invention, it is possible for a user to easily select messages related to an interesting region among posted messages. Since a hashtag is conventionally used for a posted message, the use of the hashtag enables a user to easily obtain posted messages related to a region from a large number of posted messages.

In addition, posted messages are grouped into categories based on a transportation means according to an embodiment of the present invention. Thus, a user can easily select information associated with an interesting category. Regarding grouping into categories, by using of Twitter_ID only used to post messages in a predetermined category, it is possible to automatically extract words related to the category, thereby the grouping of the category can be simplified.

For convenience of explanation, the apparatus according to the embodiments of the present invention have been described with reference to functional block diagrams, but the apparatus may be implemented in hardware, software, or combinations thereof. In addition, two or more functional elements may be combined as appropriate.

For convenience of explanation, the method according to the embodiments of the present invention have been described with reference to flowcharts, but the method may be carried out in a different order from the order shown in the embodiments.

While the embodiments of the present invention are described above, the present invention is not limited to the these embodiments, and variations, modifications, alterations, and substitutions can be made by those skilled in the art without deviating from the spirit of the present invention.

The present international application is based on and claims the benefit of priority of Japanese Patent Application No. 2011-086054 filed on Apr. 8, 2011, the entire contents of which are hereby incorporated by reference.

### DESCRIPTION OF NOTATIONS

10 regional information distribution server
101 posted message obtaining unit
103 category grouping unit
105 word extracting unit
107 location information receiving unit
109 movement route determining unit
111 destination estimating unit
113 transportation means determining unit
115 associated posted message obtaining unit
117 associated posted message distributing unit
151 hashtag information storage unit
153 railroad and road information storage unit
155 shop information storage unit
157 posted message storage unit
159 category information storage unit
161 location information storage unit
163 movement route information storage unit
20 mobile terminal
201 location information obtaining unit
203 associated posted message receiving unit
205 displaying unit

1. A regional information distribution server for distributing regional information to a mobile terminal, comprising:
a posted message obtaining unit configured to obtain posted messages related to a region from a server for storing posted messages;
a location information receiving unit configured to receive location information of the mobile terminal from the mobile terminal;
a transportation means determining unit configured to determine a transportation means of a user of the mobile terminal based on the location information of the mobile terminal;
an associated posted message obtaining unit configured to obtain a posted message associated with the location information of the mobile terminal from the posted messages obtained by the posted message obtaining unit;
a category grouping unit configured to group the posted messages obtained by the posted message obtaining unit into predetermined categories and assign the categories to the posted messages obtained by the posted message obtaining unit; and
an associated posted message distributing unit configured to distribute the posted message obtained by the associated posted message obtaining unit to the mobile terminal; wherein
the associated posted message obtaining unit assigns priorities to the categories based on the transportation means of the user of the mobile terminal, and
the associated posted message distributing unit distributes the posted message obtained by the associated posted message obtaining unit together with the category assigned by the category grouping unit and the priority assigned to the category by the associated posted message obtaining unit to the mobile terminal.

2. The regional information distribution server as claimed in claim 1, wherein
the category grouping unit groups the posted messages into the predetermined categories which are determined in advance based on user identification assigned to the posted messages.

3. The regional information distribution server as claimed in claim 1, wherein
the category grouping unit groups the posted messages including a word matching or similar to a related word corresponding to a category into the category.

4. The regional information distribution server as claimed in claim 1, wherein
the category grouping unit groups the posted messages into the predetermined categories based on similarity between semantic space vectors of the categories generated based on related words corresponding to the categories and semantic space vectors of the posted messages.

5. The regional information distribution server as claimed in claim 3, further comprising:
a word extracting unit configured to extract a word whose frequency of appearance is above a predetermined threshold from words included in the posted messages, as the related word corresponding to one of the predetermined categories which are determined in advance based on user identification assigned to the post messages, wherein
the category grouping unit groups the posted messages including a word matching or similar to the extracted related word into the category corresponding to the related word.

6. The regional information distribution server as claimed in claim 1, wherein
the associated posted message obtaining unit assigns a priority to the posted message based on the location information of the mobile terminal, and
the associated posted message distributing unit distributes the posted message obtained by the associated posted message obtaining unit together with the category assigned by the category grouping unit, the priority assigned to the category, and the priority assigned to the posted message by the associated posted message obtaining unit to the mobile terminal.

7. The regional information distribution server as claimed in claim 1, further comprising:
a movement route determining unit configured to determine a movement route of a user of the mobile terminal based on the location information of the mobile terminal, calculate a count of movements based on a comparison between the movement route and previous movement routes, and store the movement route and the count of movements in a movement route information storage unit; and
a destination estimating unit configured to estimate a destination and the movement route of the user of the mobile terminal based on the location information of the mobile terminal and the movement route of the mobile terminal stored in the movement route information storage unit; wherein
the associated posted message obtaining unit assigns a priority to the posted messages based on the count of movement, and
the associated posted message distributing unit distributes the posted message obtained by the associated posted message obtaining unit together with the priority assigned by the associated posted message obtaining unit to the mobile terminal.

8. The regional information distribution server as claimed in claim 7, wherein:
the associated posted message distributing unit distributes the posted message when the distance to the mobile terminal is below a predetermined threshold or when the count of movements along the movement route is above a predetermined threshold.

9. The regional information distribution server as claimed in claim 7, further comprising:
a railroad and road information storage unit configured to store information about railroads and roads; wherein
the movement route determining unit associates the determined movement route with a railroad or road stored in the railroad and road information storage unit, and
the associated posted message distributing unit distributes the posted message when the posted message corresponds to the railroad or road determined by the movement route determining unit.

10. The regional information distribution server as claimed in claim 1, wherein:
the posted message obtaining unit obtains the posted messages related to the region based on text in the posted messages or tags assigned to the posted messages.

11. A mobile terminal for receiving regional information from a regional information distribution server, comprising:
a location information obtaining unit configured to obtain location information of the mobile terminal and transmit the location information to the regional information distribution server;
an associated posted message receiving unit configured to receive from the regional information distribution server a posted message associated with the location information of the mobile terminal, a category of the posted message, and a priority assigned to the category based on a transportation means of the mobile terminal among posted messages related to a region obtained by the regional information distribution server from a server for storing posted messages; and
a displaying unit configured to display the posted message received by the associated posted message receiving unit based on the category of the posted message and the priority assigned to the category received by the associated posted message receiving unit.

12. The mobile terminal as claimed in claim 11, wherein:
when the associated posted message receiving unit receives a priority assigned to the posted message, the displaying unit displays the posted message based on the category of the posted message, the priority assigned to the category, and the priority assigned to the posted message received by the associated posted message receiving unit.

13. A mobile terminal for displaying regional information, comprising:
a posted message obtaining unit configured to obtain posted messages related to a region from a server for storing posted messages;
a location information obtaining unit configured to obtain location information of the mobile terminal;
a transportation means determining unit configured to determine a transportation means of a user of the mobile terminal based on the location information of the mobile terminal;
an associated posted message obtaining unit configured to obtain a posted message associated with the location information of the mobile terminal from the posted messages obtained by the posted message obtaining unit;
a category grouping unit configured to group the posted messages obtained by the posted message obtaining unit into predetermined categories and assign the categories to the posted messages obtained by the posted message obtaining unit; and
a displaying unit configured to display the posted message obtained by the associated posted
message obtaining unit; wherein
the associated posted message obtaining unit assigns priorities to the categories based on the transportation means of the user of the mobile terminal, and
the displaying unit displays the posted message obtained by the associated posted message obtaining unit based on the category assigned by the category grouping unit and the priority assigned to the category by the associated posted message obtaining unit.

14. The mobile terminal as claimed in claim 11, wherein:
the displaying unit displays the posted message on a lock screen for protecting against an erroneous operation.

15. A regional information distribution system including a mobile terminal and a regional information distribution server for distributing regional information to the mobile terminal, the system comprising:
the regional information distribution server including
a posted message obtaining unit configured to obtain posted messages related to a region from a server for storing posted messages;
a location information receiving unit configured to receive location information of the mobile terminal from the mobile terminal;
a transportation means determining unit configured to determine a transportation means of a user of the mobile terminal based on the location information of the mobile terminal;
an associated posted message obtaining unit configured to obtain a posted message associated with the location information of the mobile terminal from the posted messages obtained by the posted message obtaining unit;
a category grouping unit configured to group the posted messages obtained by the posted message obtaining unit into predetermined categories and assign the categories to the posted messages obtained by the posted message obtaining unit; and
an associated posted message distributing unit configured to distribute the posted message obtained by the associated posted message obtaining unit to the mobile terminal; wherein
the associated posted message obtaining unit assigns priorities to the categories based on the transportation means of the user of the mobile terminal, and
the associated posted message distributing unit distributes the posted message obtained by the associated posted message obtaining unit together with the category assigned by the category grouping unit and the priority assigned to the category by the associated posted message obtaining unit to the mobile terminal; and
the mobile terminal including
a location information obtaining unit configured to obtain location information of the mobile terminal and transmit the location information to the regional information distribution server;
an associated posted message receiving unit configured to receive the posted message, the category of the posted message, and the priority assigned to the category distributed from the regional information distribution server; and
a displaying unit configured to display the posted message received by the associated posted message receiving unit based on the category of the posted message and the priority assigned to the category received by the associated posted message receiving unit.

16. The regional information distribution system as claimed in claim 15, wherein:
the associated posted message obtaining unit assigns a priority to the posted message based on the location information of the mobile terminal,
the associated posted message distributing unit distributes the posted message obtained by the associated posted message obtaining unit together with the category assigned by the category grouping unit, the priority assigned to the category, and the priority assigned to the posted message by the associated posted message obtaining unit to the mobile terminal, and
the displaying unit displays the posted message based on the category of the posted message, the priority assigned to the category, and the priority assigned to the posted message received by the associated posted message receiving unit.

17. A regional information distribution method in a regional information distribution server for distributing regional information to a mobile terminal, the method comprising the steps of:
obtaining posted messages related to a region from a server for storing posted messages;
receiving location information of the mobile terminal from the mobile terminal;
determining a transportation means of a user of the mobile terminal based on the location information of the mobile terminal;
obtaining a posted message associated with the location information of the mobile terminal from the posted messages related to the region;
grouping the obtained posted messages into predetermined categories and assigning the categories to the obtained posted messages;
assigning priorities to the categories based on the transportation means of the user of the mobile terminal; and
distributing the posted message associated with the location information of the mobile terminal together with the assigned category and the priority assigned to the category to the mobile terminal.

18. A regional information display method in a mobile terminal for displaying regional information, the method comprising the steps of:
obtaining posted messages related to a region from a server for storing posted messages;
obtaining location information of the mobile terminal;
obtaining a posted message associated with the location information of the mobile terminal, a category of the posted message, and a priority assigned to the category based on a transportation means of the mobile terminal from the posted messages related to the region; and
displaying the posted message associated with the location information of the mobile terminal based on the obtained category of the posted message and the priority assigned to the category.

19. The regional information distribution server as claimed in claim 9, wherein
the transportation means determining unit determines the transportation means based on a movement speed calculated from the location information of the mobile terminal during a predetermined time period and a step count obtained by the mobile terminal as follows:
1) when the movement speed is above a first speed threshold,
1-1) if the step count is above a step count threshold, the transportation means of the user of the mobile terminal is determined as a bicycle,
1-2) else if the step count is below the step count threshold and if a distance between the location information of the mobile terminal and a route of a railroad stored in the railroad and road information storage unit is below a distance threshold, the transportation means of the user of the mobile terminal is determined as a train,
1-3) else, the transportation means of the user of the mobile terminal is determined as a car,
2) except for the case 1) and when the step count is above the step count threshold,
2-1) if the movement speed is below a second speed threshold slower than the first speed threshold, the transportation means of the user of the mobile terminal is determined as walking, and
2-2) else, the transportation means of the user of the mobile terminal is determined as a bicycle.

20. The regional information distribution server as claimed in claim 9, wherein
the movement route determining unit determines the movement route of the user of the mobile terminal based on a cumulative amount of overlap between a first area and a second area, the first area being represented as either a rectangle with a diagonal line formed by adjacent representative points along with a route stored in the railroad and road information storage unit or a circle with a diameter formed by the representative points, the second area being represented as either a rectangle, twice a size of a measurement error on a side, centered at a position of the mobile terminal or a circle with a radius of the measurement error.

21. The regional information distribution server as claimed in claim 7, wherein
the movement route determining unit stores passage areas of the movement route of the mobile terminal in the movement route information storage unit, and
the destination estimating unit determines whether the movement route of the mobile terminal corresponds to one of the previous movement routes based on whether a passage area determined from the location information of the mobile terminal overlaps a minimum rectangular area which includes a predetermined number of passage areas in the previous movement route stored in the movement route information storage unit, the predetermined number of passage areas being obtained in ascending order of a distance from the passage area, calculates a probability that the mobile terminal moves along the determined previous movement route based on the determined previous movement route and the count of movement, and estimates an area to be visited after a present area of the mobile station based on the probability.
